(19) United States
(12) Patent Application Publication
(10) Pub. No.: US 2015/0084984 A1
(43) Pub. Date: Mar. 26, 2015

(54) ELECTRONIC DEVICE

(71) Applicant: NIKON CORPORATION, Tokyo (JP)

(72) Inventors: Hiromi Tomii, Yokohama-shi (JP); Sayako Yamamoto, Kawasaki-shi (JP); Mitsuko Matsumura, Sagamihara-shi (JP); Saeko Samejima, Tokyo (JP); Yae Nakamura, Kawasaki-shi (JP); Masakazu Sekiguchi, Kawasaki-shi (JP)

(21) Appl. No.: 14/389,049

(22) PCT Filed: Oct. 5, 2012
(86) PCT No.: PCT/JP2012/075928

§ 371 Date: Sep. 29, 2014

(30) Foreign Application Priority Data
Mar. 27, 2012 (JP) 2012-072215
Mar. 27, 2012 (JP) 2012-072216
Mar. 27, 2012 (JP) 2012-072217

(51) Int. Cl. G06T 11/60; H04N 7/18

(52) U.S. Cl. CPC G06T 11/60; H04N 7/181; G06T 2207/10004; G06T 2207/10024; G06T 2207/20221; G06T 2215/16
USPC 345/619

(57) ABSTRACT

To improve the usability of an electronic device, the electronic device includes: a first camera provided to a main unit, a second camera provided to the main unit at a different location form the first camera, a first orientation detection sensor configured to detect an orientation of the main unit, and a control unit configured to carry out image capturing by the first and second cameras depending on a detection result of the first orientation detection sensor.

### TECHNICAL FIELD

The present invention relates to electronic devices.

### BACKGROUND ART

There has been conventionally suggested a life log system that records activities of an individual's life. In the life log system, there has been suggested a system that presents candidate activities by using the action or the state of a user (see Patent Document 1, for example).

### PRIOR ART DOCUMENTS

### Patent Documents

Patent Document 1: Japanese Patent Application Publication No. 2010-146221

### SUMMARY OF THE INVENTION

### Problems to be Solved by the Invention

However, the conventional life log system does not sufficiently reduce the cumbersome input operation of the user, and is not user-friendly.

The present invention has been made in the view of the above problems, and aims to provide electronic devices having a high degree of usability.

### Means for Solving the Problems

The electronic device of the present invention includes a first camera provided to a main unit; a second camera provided to the main unit at a different location from the first camera; a first orientation detection sensor detecting an orientation of the main unit; and a control unit configured to carry out image capturing by the first and second cameras depending on a detection result of the first orientation detection sensor.

In this case, the control unit may restrict image capturing by at least one of the first and second cameras depending on the detection result of the first orientation detection sensor. In addition, the first camera may be provided to a first surface of the main unit, and the second camera may be provided to second surface different from the first surface. In addition, at least one of an operation unit and a display unit may be provided to the first surface of the main unit.

In the present invention, a second orientation detection sensor detecting a posture of a user carrying the main unit may be provided. In this case, the control unit may change, depending on a detection result of the second orientation detection sensor, at least one of a photographing condition of the second camera and a process executed after image capturing by the second camera.

In the present invention, a distance sensor detecting a distance to a user holding the main unit may be provided. In addition, the control unit may carry out image capturing by at least one of the first and second cameras when a user is holding the main unit. In addition, a biosensor acquiring biological information may be provided to the main unit.

The electronic device of the present invention may include a synthesizing unit configured to synthesize an image captured by the first camera and an image captured by the second camera. In addition, the electronic device of the present invention may include a third camera provided to the surface of the main unit to which the first camera is provided at a different location from the first camera. In addition, the electronic device of the present invention may include a memory storing data about clothes. In this case, a comparing unit configured to compare the data stored in the memory and image data captured by the first and second cameras may be provided. In addition, the electronic device of the present invention may include an acquiring unit configured to acquire data about clothes from an external device.

The electronic device of the present invention includes an action detection sensor detecting an action of a user; an orientation detection sensor detecting an orientation of a main unit; a processing unit provided to the main unit and carrying out a process; and a control unit configured to control the process by the processing unit based on detection results of the action detection sensor and the orientation detection sensor.

In this case, the control unit may carry out the process by the processing unit when an output from the action detection sensor becomes less than a predetermined value. In addition, the processing unit may be an image capture unit carrying out image capturing.

The electronic device of the present invention includes an acquiring unit configured to acquire image data of articles of clothing of a user; and an identifying unit configured to identify a combination of the articles of clothing based on the image data.

In this case, an image capture unit provided to a main unit may be provided, and the image capture unit captures an image of the articles of clothing of the user when the main unit is held by the user. In addition, the identifying unit may identify the combination of the articles of clothing based on color information of the image data. In addition, a face recognition unit configured to recognize a face of the user based on the image data may be provided.

In addition, in the electronic device of the present invention, the identifying unit may detect a layer of clothing based on the image data. In this case, the identifying unit may detect the layer of clothing based on collar parts of the articles of clothing. In addition, the identifying unit may detect the layer of clothing based on a detection result of a skin of the user. In addition, the identifying unit may detect the layer of clothing based on difference in patterns when a clothing part of the image data is enlarged.

In the electronic device of the present invention, the image capture unit may include a first camera, and a second camera located a predetermined distance away from the first camera. In this case, the first camera and the second camera may be provided to different surfaces of the main unit. In addition, the electronic device of the present invention may include a memory storing data about articles of clothing. In this case, the memory may store frequency of a combination of the articles of clothing. In addition, a display unit displaying the frequency of the combination of the articles of clothing within a predetermined period stored in the memory may be provided.

In the electronic device of the present invention, the identifying unit may identify at least one of a hairstyle of a user and an accessory worn by the user based on the image data.

The electronic device of the present invention includes a memory storing information about an article of clothing owned by a user; and an input unit configured to input information about an article of clothing not stored in the memory.

In this case, a display unit displaying the information about the article of clothing stored in the memory depending on the information about the article of clothing input to the input unit may be provided. In this case, the display unit may display, when the information about the article of clothing input to the input unit belongs to a first category, information about an article of clothing belonging to a second category from the memory, the second category differing from the first category. In addition, the display unit may display the information about the article of clothing input to the input unit in combination with the information about the article of clothing stored in the memory. In addition, a detection unit configured to detect information about an article of clothing similar to the information about the article of clothing input to the input unit from the information about the article of clothing stored in the memory may be provided, and the display unit may display the information about the similar article of clothing detected by the detection unit. In the present invention, a body-shape change detection unit configured to detect a change in a shape of a body of the user based on the information about the article of clothing input to the input unit may be provided.

The electronic device of the present invention includes: an acquiring unit configured to acquire information about an article of clothing of a person other than a user; and an input unit configured to input information about an article of clothing specified by the user.

In this case, a comparing unit configured to compare the information about the article of clothing of the person other than the user to the information about the article of clothing specified by the user may be provided. In addition, a display unit displaying a comparison result by the comparing unit may be provided.

In addition, information input to the input unit may include information about a hue of the article of clothing, and a first extracting unit configured to extract information about a hue same as or close to the hue from the information about the article of clothing stored in the memory may be provided. In addition, information input to the input unit may include information about a size of the article of clothing, and a second extracting unit configured to extract information according to the size from the information about the article of clothing stored in the memory may be provided. In this case, the second extracting unit may extract information about an article of clothing belonging to a category same as a category of the article of clothing input to the input unit. Alternatively, the second extracting unit may extract information about an article of clothing belonging to a category different from a category of the article of clothing input to the input unit.

In the electronic device of the present invention, information input to the input unit may include information about a pattern of the article of clothing, and a restricting unit configured to restrict extraction of information from the information about the article of clothing stored in the memory depending on the pattern may be provided.

### Effects of the Invention

The present invention has advantages in providing electronic devices having a high degree of usability.

### BRIEF DESCRIPTION OF DRAWINGS

FIG. 1 is a diagram illustrating a configuration of an information processing system in accordance with an embodiment;

FIG. 2A is a diagram illustrating a mobile terminal viewed from the front side (the −Y side), and FIG. 2B is a diagram illustrating the mobile terminal viewed from the back side (the +Y side);

FIG. 3 is a block diagram illustrating the mobile terminal and an external device;

FIG. 4A is a diagram illustrating a distance between an image capture unit 30 and a user, FIG. 4B is a diagram for explaining the focal length of a first camera, and

FIG. 4C is a diagram for explaining the focal length of a second camera;

FIG. 5A through FIG. 5F are diagrams illustrating examples of articles of clothing of a user;

FIG. 6 is a flowchart illustrating a process of detecting clothes of the user;

FIG. 7 is a flowchart illustrating a process of informing the user of the clothes;

FIG. 8 is a flowchart illustrating a process of suggesting coordinates with a new article of clothing;

FIG. 9 is a diagram illustrating a clothing DB; and

FIG. 10 is a diagram illustrating a clothes log.

### MODES FOR CARRYING OUT THE INVENTION

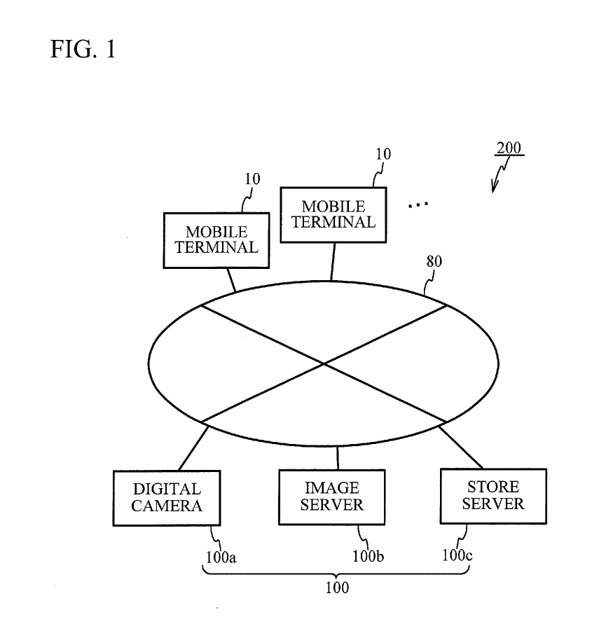

Hereinafter, a detailed description will be given of an embodiment with reference to FIG. 1 through FIG. 10. FIG. 1 illustrates a block diagram of a configuration of an information processing system 200 in accordance with the embodiment.

The information processing system 200 includes mobile terminals 10 and external devices 100 as illustrated in FIG. 1. The mobile terminals 10 and the external devices 100 are connected to a network 80 such as the Internet.

The mobile terminal 10 is an information device used while being carried by a user. The mobile terminal 10 may be a mobile phone, a smartphone, a PHS (Personal Handy-phone System), a PDA (Personal Digital Assistant) or the like. In the present embodiment, assume that the mobile terminal 10 is a smartphone. The mobile terminal 10 has a telephone function, a communication function for connecting to the Internet and the like, and a data processing function for executing programs.

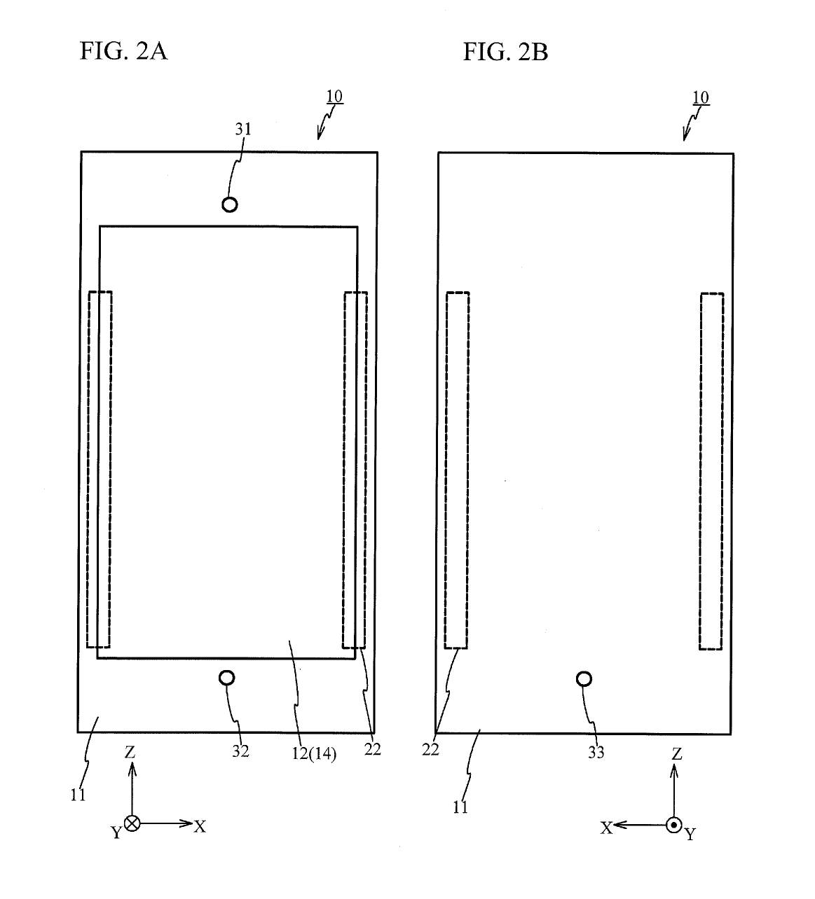

FIG. 2A is a diagram illustrating the mobile terminal 10 viewed from the front side (the −Y side), and FIG. 2B is a diagram illustrating the mobile terminal 10 viewed from the back side (the +Y side). As illustrated in these diagrams, the mobile terminal 10 has a thin plate-like shape having a rectangle principal surface (the −Y surface) and a size held by a palm.

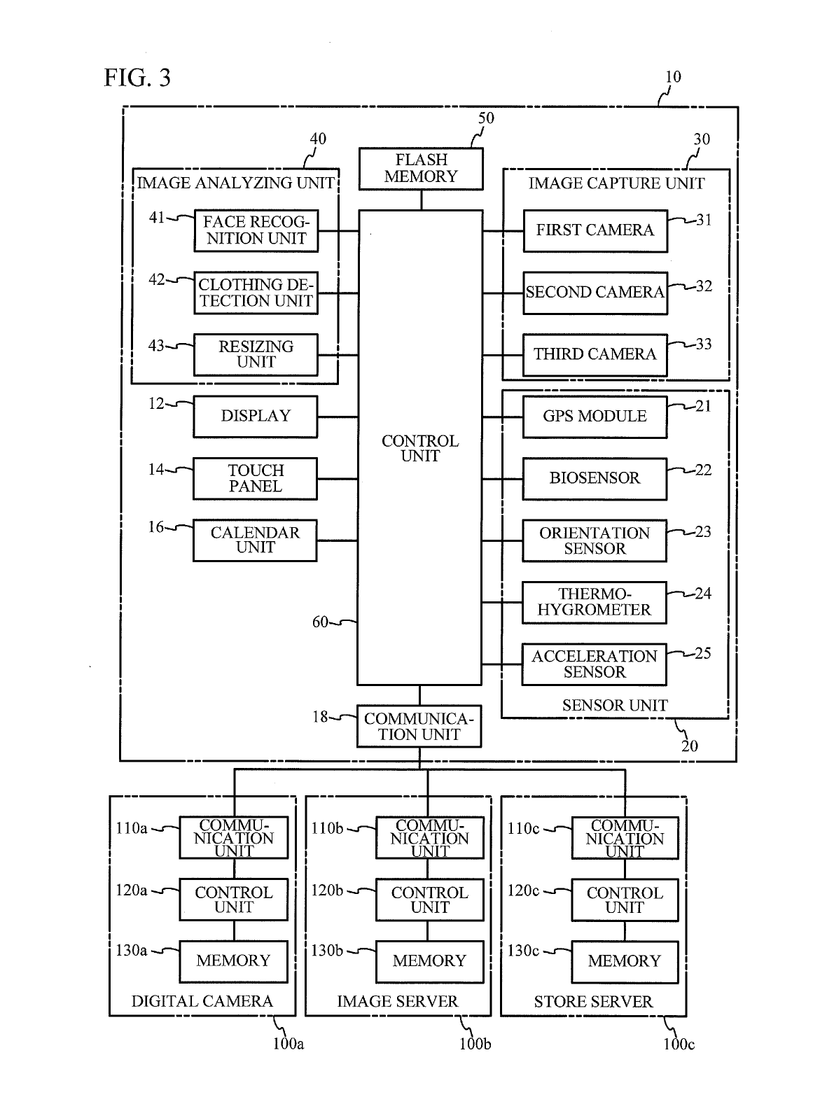

FIG. 3 illustrates a block diagram of the mobile terminal 10 and the external devices 100. As illustrated in FIG. 3, the mobile terminal 10 includes a display 12, a touch panel 14, a calendar unit 16, a communication unit 18, a sensor unit 20, an image capture unit 30, an image analyzing unit 40, a flash memory 50, and a control unit 60.

The display 12 is located at the principal surface (the −Y surface) side of a main unit 11 of the mobile terminal 10 as illustrated in FIG. 2A. The display 12 has a size covering a most region (e.g. 90%) of the principal surface of the main unit 11, for example. The display 12 displays images, various pieces of information, and images for operation inputs such as buttons. The display 12 is, for example, a device employing a liquid crystal display element.

The touch panel 14 is an interface capable of inputting information responding to the touch by a user to the control unit 60. The touch panel 14 is provided on the surface of the display 12 or in the display 12 as illustrated in FIG. 2A, and thereby, the user can intuitively input various pieces of information by touching the surface of the display 12.

The calendar unit 16 acquires time information such as year, month, day, and time, and outputs it to the control unit 60. The calendar unit 16 further has a time measuring function.

The communication unit 18 communicates with the external devices 100 on the network 80. The communication unit 18 includes a wireless communication unit accessing a wide area network such as the Internet, a Bluetooth (registered trademark) unit allowing the communication with Bluetooth (registered trademark), and a FeliCa (registered trademark) chip, and communicates with the external devices 100 and other mobile terminals.

The sensor unit 20 includes sensors. In the present embodiment, the sensor unit 20 includes a GPS (Global Positioning System) module 21, a biosensor 22, an orientation sensor 23, a thermo-hygrometer 24, and an acceleration sensor 25.

The GPS module 21 is a sensor detecting the position (e.g. the latitude and the longitude) of the mobile terminal 10.

The biosensor 22 is located, for example, at two points on the back surface of the main unit 11 of the mobile terminal 10 as illustrated in FIG. 2A and FIG. 2B, and is a sensor acquiring the state of the user holding the mobile terminal 10. The biosensor 22 acquires, for example, the body temperature, the blood pressure, the pulse, and the perspiration amount of the user. A sensor that may be employed as the above described biosensor 22 is, for example, a sensor that emits a light beam to a user from a light emitting diode and receives the reflected light of the light beam from the user to detect the pulse as disclosed in Japanese Patent Application Publication No. 2001-276012 (U.S. Pat. No. 6,526,315), or a watch-type biosensor disclosed in Japanese Patent Application Publication No. 2007-215749 (U.S. Patent Application Publication No. 2007-191718). The biosensor 22 may be located at the front surface side or the long side portion of the main unit 11.

Additionally, the biosensor 22 includes a sensor (pressure sensor) acquiring information about a force of the user holding the mobile terminal 10 (e.g. a grip strength). The above described pressure sensor can detect whether the mobile terminal 10 is held by the user and the magnitude of the force holding the mobile terminal 10. The control unit 60 described later may start acquiring information by other biosensors when the pressure sensor detects that the user holds the mobile terminal 10. The control unit 60 may turn on other functions (or return them from a standby state) when the pressure sensor detects that the user holds the mobile terminal 10 in the state where the power is ON.

The orientation sensor 23 is provided inside the mobile terminal 10 and detects the orientation of the mobile terminal 10 to detect the orientations of the first camera 31, the second camera 32, and a third camera 33 described later. The orientation sensor 23 may be structured by combining sensors, each detecting an orientation in a single axis direction by whether a small sphere moving by the gravity blocks infrared rays of a Photo-interrupter. However, this does not intend to suggest any limitation, and a three-axis acceleration sensor or a gyro sensor may be employed as the orientation sensor 23.

The thermo-hygrometer 24 is an environmental sensor detecting the temperature around the mobile terminal 10. Instead of the thermo-hygrometer 24, the mobile terminal 10 may include a thermometer and a hygrometer separately. The thermo-hygrometer 24 may be configured to share the function detecting the body temperature of the user by the biosensor 22.

As the acceleration sensor 25, used is a piezoelectric element, a strain gauge, or the like. In the present embodiment, the acceleration sensor 25 is used to detect whether the user is standing or sitting. The acceleration sensor 25 detects an acceleration along a Z-axis direction in FIG. 2A. Acceleration sensors detecting accelerations along an X-axis and a Y-axis in FIG. 2A may be provided, and in this case, the moving direction of the user can be detected with the acceleration sensors. The method of detecting whether a user is standing, sitting, walking, or running with an acceleration sensor is disclosed in, for example, Japanese Patent No. 3513632 (Japanese Patent Application Publication No. 8-131425). A gyro sensor detecting an angular velocity may be used instead of the acceleration sensor 25, or together with the acceleration sensor 25.

The image capture unit 30 includes a first camera 31, a second camera 32, and a third camera 33. The first camera 31 is located above (the +Z direction) the display 12 on the principal surface (the surface at the −Y side) of the main unit 11, the second camera 32 is located below (the −Z direction) the display 12, and the third camera 33 is located on the surface opposite to the principal surface of the main unit 11 (the surface at the +Y side) and lower (the −Z direction) than the first camera 31 as illustrated in FIG. 2A and FIG. 2B. The image capture unit 30 captures an image of the situation (e.g. the clothes) of the user while the user is holding (using) the mobile terminal 10 to obtain the log of the situation of the user without forcing a user to perform a particular operation.

The first camera 31 captures an image of the face and the clothes, such as a hat; a necktie; accessories; a hairstyle; and articles of clothing, of the user who is operating the mobile terminal 10.

The second camera 32 captures an image of the upper body of the user who is operating the mobile terminal 10, and can also capture an image of the lower body of the user depending on the orientation of the mobile terminal 10.

The third camera 33 captures an image of the article of clothing on the lower body and the feet of the user. The third camera 33 is located at the lower side (near the edge at the −Z side) of the surface opposite to the display 12 so as to capture the image of the article of clothing on the lower body and the feet of the user and not to be covered by the user's hand.

The cameras 31˜33 of the image capture unit 30 have the same basic structure designed to include an imaging lens and an imaging element (a CCD and a CMOS devices), but their focal lengths of the imaging lenses differ from each other. A liquid lens may be used as the imaging lens. The imaging element of each of the cameras making up the image capture unit 30 includes a color filter in which RGB three primary colors are Bayer-arranged for example, and outputs color signals corresponding to respective colors. Hereinafter, a description will be given of the focal lengths of the cameras 31˜33.

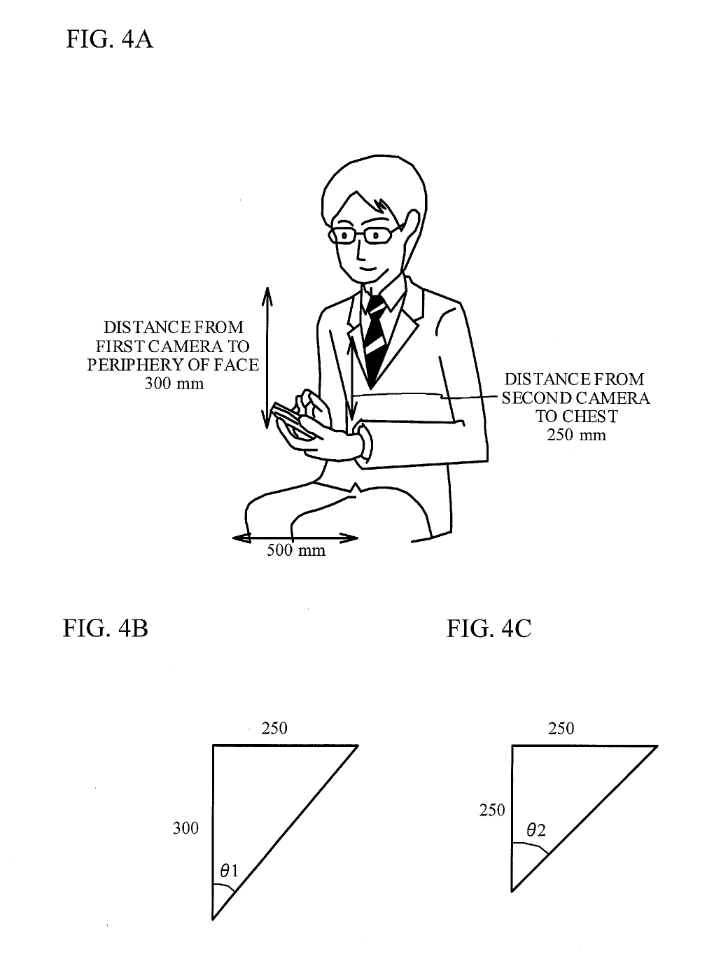

FIG. 4A is a diagram illustrating a distance between the image capture unit 30 and the user. As illustrated in FIG. 4A, in a state where the user holds the mobile terminal 10, the distance from the first camera 31 to the periphery of the face of the user is approximately 300 mm. When assumed that the first camera 31 needs to capture an image with the length of shoulders (approximately 500 mm), the half angle of view in the short-side direction of the first camera 31 is θ1≈39.8° (because tan θ1=250/300). Thus, in the present embodiment, the focal length of the first camera 31 is equivalent to 14 mm on a 35 mm film size camera.

In contrast, the distance from the second camera 32 to the upper body (the chest) of the user is approximately 250 mm. When assumed that the second camera 32 needs to capture an image with the length of shoulders (approximately 500 mm), the half angle of view in the short-side direction of the second camera 32 is θ2=45° (because tan θ2=250/250) as illustrated in FIG. 4B. Thus, in the present embodiment, the focal length of the second camera 32 is equivalent to 12 mm on a 35 mm film size camera. That is to say, the angle of view of the second camera 32 is wider than that of the first camera 31.

The third camera 33 is assumed to have an optical system having the same half angle of view and the same focal length as the first camera 31. There is a case in which the third camera 33 captures an image of the feet of the user when the user is standing. In this case, if the half angle of view in the short-side direction is approximately 39.8°, an image of the feet other than the feet of the user may be captured. In such a case, the after-mentioned control unit 60 may trim the image so that only the image of the region within which the user is thought to be present is saved based on the orientation of the third camera 33 (the orientation of the mobile terminal 10 detected by the orientation sensor 23). Alternatively, the control unit 60 may move a zoom optical system pre-arranged in the third camera 33 to the telephoto direction to capture the image of the feet of the user when it can determine that the user is standing based on the output from the acceleration sensor 25. Or, the control unit 60 may stop (restrict) capturing an image by the third camera 33 when the user is standing.

The first camera 31, the second camera 32, and the third camera 33 may be configured to be capable of moving in the vertical or horizontal direction to capture images of the user and the clothes of the user in the wider area.

The image capture unit 30 captures an image while the user is operating the mobile terminal 10 and thus may be affected by the hand movement or the vibration of the vehicle. In such a case, the image capture unit 30 may capture multiple still images and synthesize the still images to eliminate the effect of the hand movement or the vibration. The image captured in this case is not for ornamental use, and its quality is sufficient if the clothes such as the articles of clothing of the user can be determined. Thus, the effect of the hand movement or the vibration may be simply eliminated by using commercially available software.

The image analyzing unit 40 analyzes images captured by the image capture unit 30 and images stored in the external device 100, and includes a face recognition unit 41, a clothing detection unit 42, and a resizing unit 43 in the present embodiment.

The face recognition unit 41 detects whether a face is contained in the image captured by the first camera 31. Furthermore, when detecting a face from the image, the face recognition unit 41 compares (e.g. pattern-matches) the image data of the part of the detected face to the image data of the face of the user stored in the flash memory 50 to recognize a person whose image is captured by the first camera 31.

The clothing detection unit 42 detects the user's clothes (articles of clothing, a bag, shoes, and the like) of which image is captured by the first camera 31, the second camera 32, and the third camera 33.

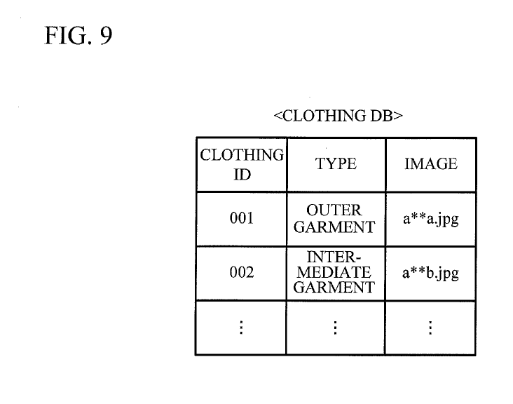

Here, when the face recognition unit 41 determines that a face is contained in the image captured by the first camera 31, the image of the article of clothing is likely to be present below the face. Therefore, the clothing detection unit 42 extracts the image of the predetermined range below the face recognized by the face recognition unit 41, and pattern-matches the extracted image to the image data stored in a clothing DB (see FIG. 9) stored in the flash memory 50 to detect the articles of clothing of the user. The clothing detection unit 42 can also detect the articles of clothing of the user by pattern-matching the image captured by the second camera 32 to the image in the clothing DB (FIG. 9) stored in the flash memory 50. The above described pattern matching may be performed by extracting partial regions to be pattern-matched with the image of the clothing DB from the whole image captured by the image capture unit 30 and selecting object images (images of an outer garment, an intermediate garment, and a suit described later) of the clothing DB for the extracted partial regions. In this case, a template image for extracting partial regions from the whole image is stored in the clothing DB, and a pattern matching between the whole image and the template image may be performed. The clothing detection unit 42 may detect the representative colors of the partial regions based on the RGB outputs (color information) from the imaging elements corresponding to the partial regions.

The clothing DB stores the data of the article of clothing worn by the user in the past, which is extracted from the images captured by the cameras 31˜33, together with a clothing ID (uniquely assigned identifier) and a clothing category as illustrated in FIG. 9. An outer garment, an intermediate garment, a suit, a jacket, Japanese clothes, a necktie, a pocket square, a coat, or the like is input to the clothing category field. In addition, the image of the characteristic shape of each article of clothing (e.g. the shape of a collar, a short sleeve, a long sleeve) may be stored as an image of the clothing data. When the user purchased goods by using the communication unit 18 (through the Internet shopping or the like), the control unit 60 may acquire the clothing data through the communication unit 18 and store it in the clothing DB. Alternatively, the control unit 60 may acquire the clothing data from the image held by the external device 100 and store it in the clothing DB.

The clothing detection unit 42 may compare the images of the article of clothing on the upper body of the user captured by the first camera 31 and the second camera 32 to the image of the article of clothing on the lower body of the user captured by the third camera 33 to determine whether the user wears a suit (a coat and pants tailored from the same cloth) or a jacket.

In addition, the clothing detection unit 42 may have two functions: (1) an image synthesizing function; and (2) a layered clothing determination function described later. These functions are implemented by software.

(1) Image Synthesizing Function

The clothing detection unit 42 synthesizes an image captured by the first camera 31 and an image captured by the second camera 32 into a single image. In this case, the clothing detection unit 42 detects an overlapping part between the image captured by the first camera 31 and the image captured by the second camera 32, and synthesizes the images based on the overlapping part for example. The clothing detection unit 42 may use the clothing data stored in the flash memory 50 as a reference to synthesize the image captured by the first camera 31 and the image captured by the second camera 32. As described, when the images are synthesized, the clothing detection unit 42 may detect the articles of clothing of the user based on the synthesized image.

(2) Layered Clothing Determination Function

The clothing detection unit 42 detects (identifies) an intermediate garment such as a Y-shirt or a T-shirt worn by the user and an outer garment such as a jacket, a sweatshirt, or a short coat worn outside the intermediate garment to determine whether the user dresses in layers.

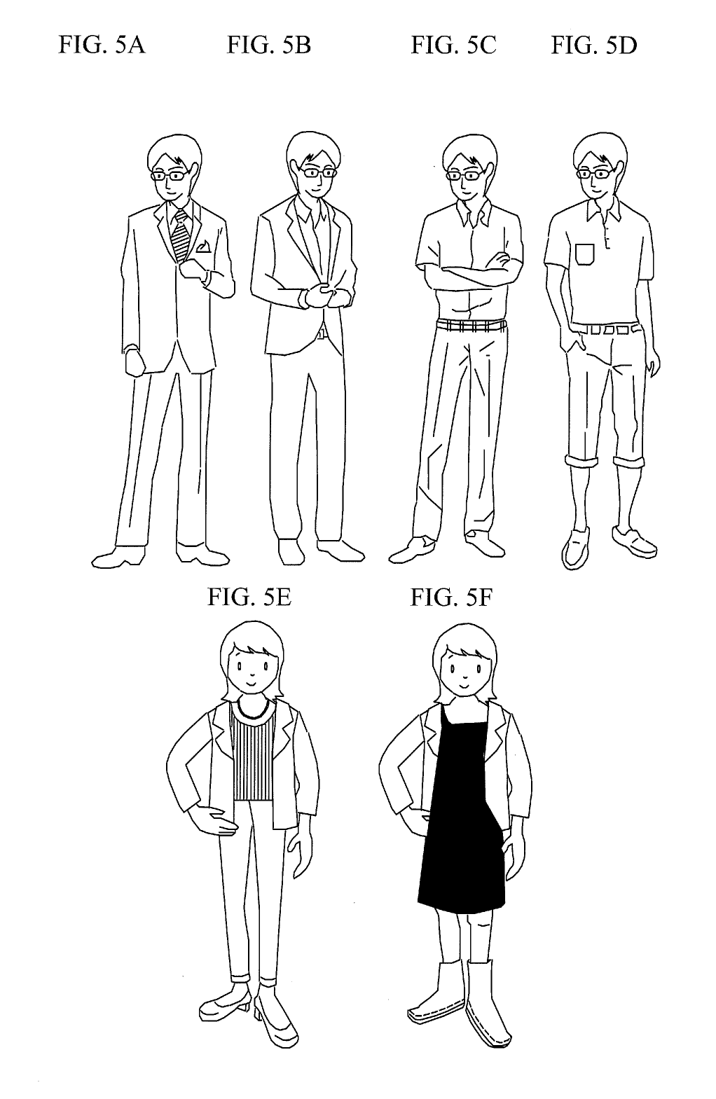

FIG. 5A˜FIG. 5F are diagrams illustrating the articles of clothing of the user, FIG. 5A˜FIG. 5D illustrate articles of clothing of a male user and FIG. 5E and FIG. 5F illustrate articles of clothing of a female user. Hereinafter, a description will be given of a concrete example of the layered clothing determination.

FIG. 5A illustrates a case where the user wears a Y-shirt, a necktie, and a suit, and FIG. 5B illustrates a case where the user wears a Y-shirt and a suit. FIG. 5C illustrates a case where the user wears a Y-shirt but does not wear a jacket, and FIG. 5D illustrates a case where the user wears a polo shirt. FIG. 5E illustrates a case where the user wears a jacket over a crew neck shirt, and FIG. 5F illustrates a case where the user wears a jacket over a dress.

In these cases, as illustrated in FIG. 5A, FIG. 5B, FIG. 5E, and FIG. 5F, when the user dresses in layers, the collar of the outer garment is located outside the collar of the intermediate garment. Therefore, the clothing detection unit 42 can determine that the user dresses in layers when detecting the image of multiple collars. In addition, as the color, the print, and the weave (pattern when the image is enlarged) are likely to be different between the intermediate garment and the outer garment, the clothing detection unit 42 may determine whether the user dresses in layers from the difference in colors, prints, and weaves. In addition, the clothing detection unit 42 may determine that the user does not dress in layers when the image capture unit 30 captures an image of an arm of the user (an upper arm, or a front arm except a wrist) or short sleeves as illustrated in FIG. 5C and FIG. 5D.

In addition, the clothing detection unit 42 may determine whether the color and the pattern of the article of clothing on the lower body are the same as those of the article of clothing on the upper body when the third camera 33 captures an image of the lower body (pants, a skirt) of the user, and determine that the user wears a suit or a dress when they are the same, and determine that the user wears a jacket or a shirt when they are different.

The use of the result of the layered clothing determination described above makes it possible to detect whether the user wears an intermediate garment and an outer garment, a suit, or a dress.

Back to FIG. 3, the resizing unit 43 detects a change in the shape of the body of the user (whether the user gains weight, loses wait, or maintains weight) based on an image captured by the first camera 31. More specifically, the resizing unit 43 uses the interval between the eyes of the user as a reference and detects a ratio of the interval between the eyes to the outline of the face or the width of shoulders standardized to a certain size. The resizing unit 43 may warn the user when a rapid change is detected in the outline or the width of shoulders in a short period of time.

In addition, it may be determined (estimated) whether the user can wear the articles of clothing worn by the user in the year ago same season or whether the user can wear the articles of clothing worn by the user last year when the user purchases an article of clothing by taking a log of the change in the shape of the body of the user by the resizing unit 43.

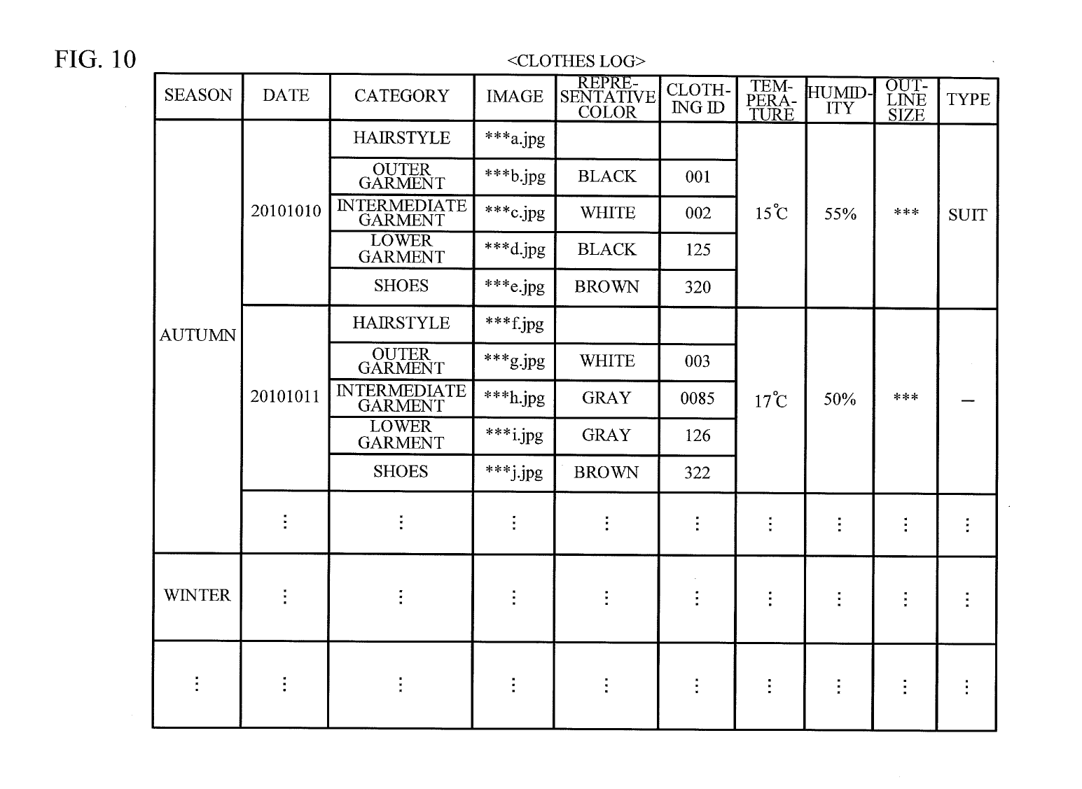

The flash memory 50 is a non-volatile semiconductor memory. The flash memory 50 stores programs executed by the control unit 60 to control the mobile terminal 10, parameters for controlling the mobile terminal 10, and clothing information (image data). Furthermore, the flash memory 50 stores various kinds of data detected by the sensor unit 20, the clothing DB (see FIG. 9), and a log of data about the articles of clothing and the outline of the user's face (a clothes log (see FIG. 10)).

The control unit 60 includes a CPU, and overall controls the information processing system 200. In the present embodiment, the control unit 60 acquires information about the articles of clothing of the user from an image captured by the image capture unit 30 while the user is operating the mobile terminal 10, and executes processes (coordinates suggestion) based on the information about the articles of clothing of the user.

Back to FIG. 1, the external device 100 includes a digital camera (hereinafter, referred to as a digital camera) 100a, an image server 100b, and a store server 100c. Each of the external devices 100 includes a communication unit, a control unit, and a memory as illustrated in FIG. 3.

The digital camera 100a is a digital camera owned by the user or a member of the user's family. A control unit 120a of the digital camera 100a extracts an image in which the user's face is recognized by an unillustrated face recognition unit from a captured image, and transmits it to the mobile terminal 10 through the communication unit 110a. Or, the control unit 120a transmits the image of the user stored in the memory 130a to the mobile terminal 10 through the communication unit 110a in response to a request from the mobile terminal 10.

The image server 100b is a server including a memory 130b storing images of registered users. The memory 130b has areas (e.g. folders) to store the respective images of the users, and includes a storage area storing images accessed only by the registered users, a storage area storing images accessed only by users that the user allows to access the images, and a storage area accessed by any users who register in the image server 100b. The control unit 120b stores an image in the storage area specified by the registered user. In addition, the control unit 120b manages the images according to the security level, and transmits, in response to the operation by a registered user, images that the registered user is allowed to access through the communication unit 110b.

In the present embodiment, the image of the user is transmitted from the image server 100b to the mobile terminal 10, and images related to the articles of clothing out of images that anyone can access are transmitted from the image server 100b to the mobile terminal 10 in response to the operation to the mobile terminal 10 by the user.

The store server 100c is a server located in a store selling clothes. The memory 130c stores the history of goods purchased by the user. The control unit 120c provides the buying history information of the user through the communication unit 110c in response to the request from the user. The examples of the buying history information are the date of purchase, the amount of money, and the image, the color, the size, and material information of an article of clothing.

In the present embodiment, as described previously, the image analyzing unit 40 identifies items such as an intermediate garment, an outer garment, a hat, a necktie, accessories, a hairstyle, and the outline of the face, but can relate an item to information about an article of clothing from the store when the item is determined to be the same as an item in the store based on the detailed information about the purchased article of clothing provided from the store. Representative images of items may be acquired from the store server 100c. When the user permits, use frequency data of the item may be provided to the store server 100c.

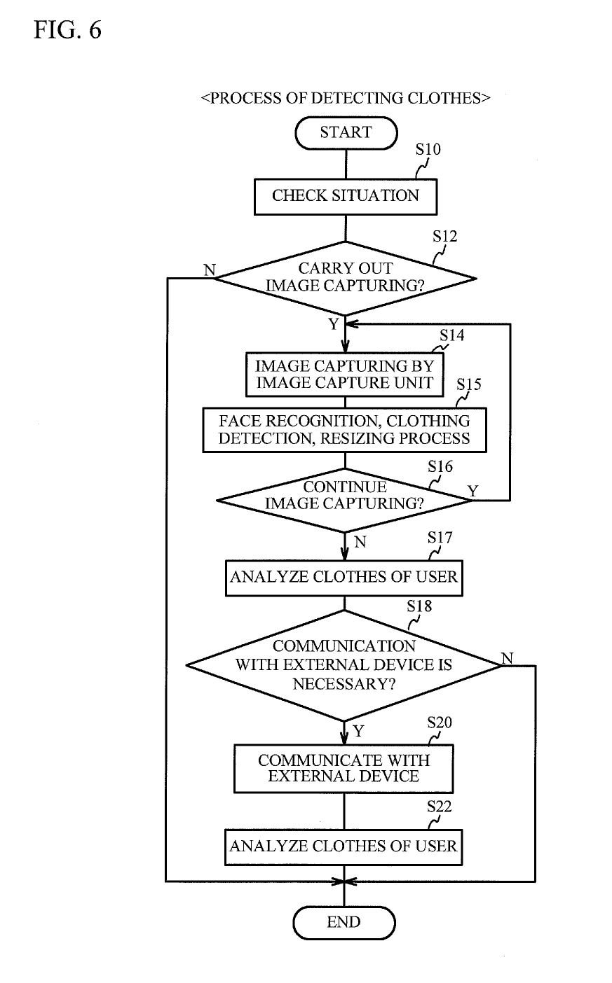

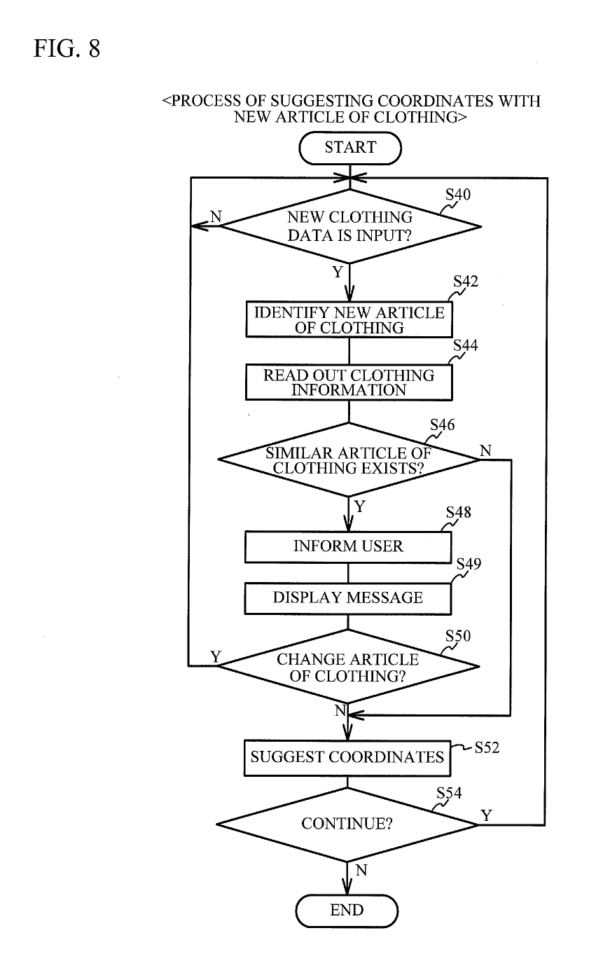

A detailed description will be given of the process executed by the information processing system 200 of the present embodiment configured as described above with reference to flowcharts of FIG. 6˜FIG. 8 and other drawings.

(Process of Detecting User's Clothes)

FIG. 6 is a flowchart of a process of detecting the user's clothes. The process of FIG. 6 starts when the biosensor 22 (a pressure sensor or the like) detects the hold of the mobile terminal 10 by the user. The process of FIG. 6 detects the user's clothes without forcing the user to perform a particular operation while the user is operating (using) the mobile terminal 10.

In the process of FIG. 6, at step S10, the control unit 60 checks the situation by using the sensor unit 20 to determine whether to carry out image capturing. More specifically, the control unit 60 acquires the position of the user by the GPS module 21, and detects whether the user is standing, sitting, or walking with the biosensor 22 and the acceleration sensor 25. Here, a description will be given under the assumption that the user is sitting and traveling on a train.

The control unit 60 detects the orientation of the mobile terminal 10 by the orientation sensor 23, and detects temperature and humidity by the thermo-hygrometer 24. The control unit 60 also acquires the current date and time from the calendar unit 16 and checks the time at which the image of the user was captured last time. Here, the control unit 60 may determine that the user wears the same articles of clothing and fail to carry out image capturing when it carried out the previous image capturing while the user was heading to work (commuting to work) and the user is currently coming back from work on the same day. However, this does not intend to suggest any limitation, and the control unit 60 may detect whether the user is wearing the same articles of clothing when an image of the user is captured at step S14 described later to determine whether to continue image capturing.

Then, at step S12, the control unit 60 determines whether to carry out image capturing by the image capture unit 30 based on the situation acquired at step S10.

Here, when the user is, for example, sitting in a train and the Z-axis of the mobile terminal 10 is inclined from the vertical by approximately 50°, the control unit 60 determines to capture images of the user and the user's clothes by the first camera 31, the second camera 32, and the third camera 33.

Assume that the first camera 31 and the second camera 32 are capable of capturing images of the user when the Z-axis of the mobile terminal 10 is inclined at from 0° to approximately 70° from the vertical direction to the direction from which the display 12 is viewable. In addition, assume that the third camera 33 is capable of capturing an image of the user when the Z-axis of the mobile terminal 10 is inclined at from approximately 5° to 90° from the vertical direction to the direction from which the display 12 is viewable.

The control unit 60 may measure a distance to the user with an ultrasonic sensor provided to the sensor unit 20, and determine whether image capturing by the first camera 31, the second camera 32, and the third camera 33 is possible based on the measurement result. A sensor other than the ultrasonic sensor may be used as a sensor for measuring a distance (a distance sensor).

When the user is walking, image capturing by the image capture unit 30 may fail, and thus the control unit 60 may hold image capturing by the image capture unit 30 until the user stops or acceleration (or angular acceleration) becomes less than or equal to a predetermined acceleration. The predetermined acceleration (or angular acceleration) may be calculated from the acceleration (or the angular acceleration) when the user is walking while holding the mobile terminal 10, and may be, for example, ½ or less or ⅓ or less of the detected value.

The control unit 60 moves to step S14 when at least one of the cameras of the image capture unit 30 can capture an image. On the other hand, when image capturing by the image capture unit 30 is impossible, the entire process of FIG. 6 is ended (step S12: N). As described above, in the present embodiment, the control unit 60 detects the state of the user from the output of the acceleration sensor 25, detects the orientation of the mobile terminal 10 from the output of the orientation sensor 23, and carry out or does not carry out image capturing by the image capture unit 30 based on the detection results. Therefore, the control unit 60 does not force the user to perform a particular operation. Not limited to image capturing by the image capture unit 30, functions or applications usable in the mobile terminal 10 may be selected or restricted based on the state of the user and the orientation of the mobile terminal 10. For example, assume that the control unit 60 determines that the user is watching the display 12 while walking. In this case, the control unit 60 can enlarge or delete the image of a certain icon menu displayed on the display 12 because the user is likely to check map information stored in the flash memory 50 but unlikely to use an application such as a game.

Moving to step S14, the control unit 60 carries out image capturing by the image capture unit 30. In this case, the control unit 60 stores image data captured by at least one of the first camera 31, the second camera 32, and the third camera 33 in the flash memory 50. Here, assume that the control unit 60 stores image data synthesized by the clothing detection unit 42 (an image formed by synthesizing images captured by the cameras, an image formed by synthesizing an image captured by the first camera 31 and an image captured by the second camera 32) in the flash memory 50.

Then, the image analyzing unit 40 recognizes the face of the user, detects the articles of clothing, and performs the resizing process at step S15 as described previously.

When image capturing is already carried out once on the same day and the articles of clothing of the user of which image was captured previously is the same as the articles of clothing of which image is captured this time, the control unit 60 may end the entire process of FIG. 6.

Then, at step S16, the control unit 60 determines whether to continue image capturing after a predetermined time (several seconds to several tens of seconds) passes after image capturing is started. At step S16, the control unit 60 determines to end image capturing when the image analyzing unit 40 finished image synthesizing and the layered clothing determination. The process goes back to step S14 when the determination at step S16 is Y (when image capturing is continued), and moves to step S17 when the determination at step S16 is N (when image capturing is ended).

Moving to step S17, the control unit 60 analyzes the user's clothes. In analyzing the user's clothes, the articles of clothing and the accessories worn by the user are identified based on the result of the clothing detection and the result of the resizing process and the clothing DB (FIG. 9), and information such as an intermediate garment, an outer garment, a hat, a necktie, a representative color of each item, accessories, a hairstyle (long hair, short hair), and an outline size is registered in the clothes log illustrated in FIG. 10. At step S17, the data of one record in the clothes log (the record on the same day) is registered as much as possible (empty sometimes).

Here, the clothes log of FIG. 10 includes a season field, a date field, a category field, an image field, a representative color field, a clothing ID field, a temperature field, a humidity field, an outline size field, and a type field. The season field stores the season determined based on the date. The date field stores the date acquired from the calendar unit 16. The category field stores the hairstyle and the category of the article of clothing detected by the clothing detection unit 42. The image field stores the image of the clothing DB and the images of the hairstyle and each article of clothing based on the process by the image capture unit 30 and the clothing detection unit 42. The representative color field stores the representative color of each article of clothing detected by the clothing detection unit 42. The temperature field and the humidity field store the temperature and the humidity detected by the thermo-hygrometer 24 respectively. The outline size field stores the detection result by the resizing unit 43. The type field stores the type of the article of clothing (a suit, a jacket, Japanese clothes, a dress, or the like) detected by the clothing detection unit 42. The clothing ID field stores, when the clothing DB contains data about the same article of clothing as the article of clothing currently worn, the ID of the same article of clothing based on the clothing DB, but becomes empty when the clothing DB does not contain the data. The season field stores the season determined by the control unit 60 based on the calendar unit 16 and the thermo-hygrometer 24.

Back to FIG. 6, moving to step S18, the control unit 60 determines whether to need to acquire information about the clothes (information about the articles of clothing) by communicating with the external device 100. In this case, the control unit 60 determines whether to need to acquire the information about the clothes (information about the articles of clothing) by communicating with the external device 100 based on whether the clothes log contains data of which the clothing ID is empty. However, assume that the control unit 60 determines that the acquisition of the information from the external device 100 is unnecessary when the entry of the clothing ID with respect to the hairstyle is empty.

When the determination at step S18 is Y, the process moves to step S20. At step S20, the control unit 60 communicates with the external device 100. For example, even when the clothing detection unit 42 detects that the user is wearing a suit, information about the suit is not stored in the clothing DB if the suit was purchased the day before. Therefore, the control unit 60 communicates with the external device 100 through the communication unit 18 to acquire the information about the suit from the external device 100 (the store server 100c) and register it to the clothing DB. The digital camera 100a or the image server 100b may not have the clothing analyzing function. In such a case, the image data stored after the previous communication or the image data that meets the condition of the color of the article of clothing may be acquired. After the process at step S20 described above, the process moves to step S22.

At step S22, the control unit 60 analyzes the user's clothes based on the new clothing data acquired from the external device 100 through the communication unit 18 again. Then, the control unit 60 ends the entire process of FIG. 6. When the determination at step S18 is N, the control unit 60 ends the entire process of FIG. 6.

As described above, the execution of the process of FIG. 6 allows the control unit 60 to take the log of the user's clothes at appropriate timing without forcing the user to perform a particular operation.

In the process of FIG. 6, the control unit 60 also stores the season in which each item is used in the clothes log based on the date (month) information of the calendar unit 16 and the output of the thermo-hygrometer 24. That is to say, the clothes log stores the information about the user's clothes with respect to each season. Some items are worn in two seasons (spring, autumn) or three seasons (spring, autumn, winter), and thus the record with respect to each season is effective.

(Clothes Inform Process)

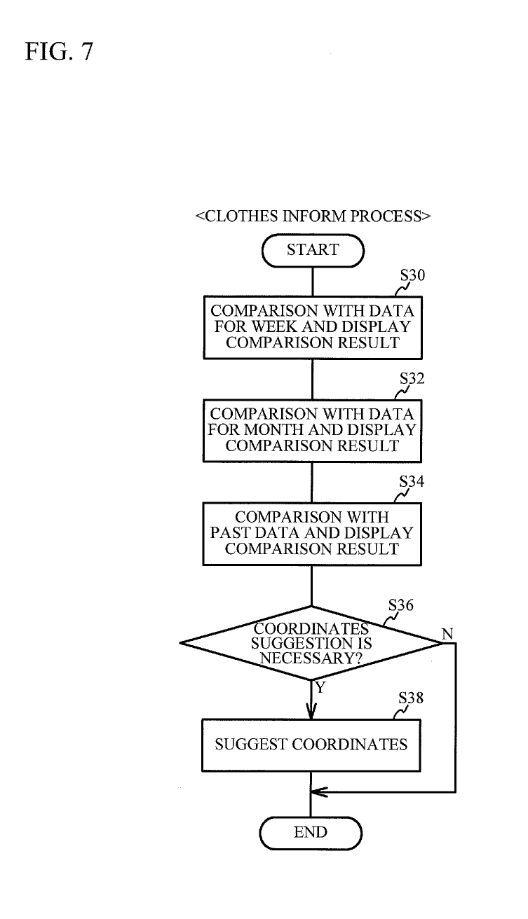

FIG. 7 is a flowchart illustrating a process of informing the user of the clothes. The process of FIG. 7 is started in response to the request from the user after the data of the clothes is acquired for the predetermined period.

At step S30 of FIG. 7, the control unit 60 executes a process of comparing data for a week and displaying the comparison result. More specifically, the control unit 60 reads out the image data of the clothes for eight days including today and previous one week stored in the clothes log, compares the articles of clothing worn today to the articles of clothing worn during the previous one week, and displays the result of the comparison.

In this case, the control unit 60 performs the comparison to determine whether there is a day during the previous one week on which the pattern of the layered clothing on the upper body is the same as today's one, whether there is a day on which the combination of the article of clothing on the upper body and the article of clothing on the lower body is the same as today's one, and whether there is a day on which the combination of the tone of the article of clothing on the upper body and the tone of the article of clothing on the lower body is the same as today's one, and displays the comparison results on the display 12. In addition, the control unit 60 displays a ranking of the articles of clothing worn during eight days including today on the display 12 when the same item does not exist or after displaying the comparison results. This allows the user to know that the user wore the same article of clothing on Monday, that the user used the combination of the white shirt and the black skirt four times during one week, or the tendency of the articles of clothing, such as that the combination pattern of representative colors of items is few.

Then, at step S32, the control unit 60 executes a process of comparing data for a month and displaying the comparison result. More specifically, the control unit 60 reads out image data of the clothes for 30 days including today stored in the flash memory 50, compares today's articles of clothing to the articles of clothing for a month, and displays the comparison result. The displayed items are the same as those displayed at step S30. However, this does not intend to suggest any limitation, and the today's articles of clothing may be compared with the articles of clothing worn on similar weather days such as rainy days, hot days, or cold days based on the measurement result of the thermo-hygrometer 24, and the comparison result may be displayed. This allows the user to know that the user wore the same article of clothing on a rainy day, or whether the user selected the articles of clothing appropriate to the temperature.

Then, at step S34, the control unit 60 performs the comparison with the past data. More specifically, the control unit 60 compares the today's articles of clothing to the articles of clothing in the same month or the same week of the past (e.g. last year or year before last), and displays the comparison result. This allows the user to check whether the user wears the same article of clothing every year, and helps the user to determine whether to purchase a new article of clothing. In addition, the user can know the change of taste in clothes, the change in the shape of the body from the detection history of the resizing unit 43, or the presence or absence of the articles of clothing that the user stops wearing. The today's articles of clothing may be compared to the articles of clothing in the month or the week of which the climate is similar to today instead of in the same month or the same week.

Then, at step S36, the control unit 60 asks the user whether coordinates suggestion is necessary. In the present embodiment, the control unit 60 displays an inquiry message on the display 12. Then, it is determined whether the coordinates suggestion is necessary based on the operation of the touch panel 14 by the user. The entire process of FIG. 7 is ended when the determination here is N, and the process moves to step S38 when the determination is Y.

Moving to step S38, the control unit 60 suggests coordinates based on the clothing information stored in the flash memory 50. At step S38, the control unit 60 acquires the image data of the hairstyle of the user of which image is captured today, and suggests the articles of clothing worn by the user having the same hairstyle, for example. Alternatively, the control unit 60 may acquire the fashion information, weather forecast, and temperature prediction from the Internet through the communication unit 18, and suggests an article of clothing based on the aforementioned information. Alternatively, the control unit 60 may suggest a combination of articles of clothing from the articles of clothing owned by the user based on the weather forecast and temperature prediction on a day during which the temperature swings wildly (changes about 10° C.) as seasons change. These processes make it possible to provide appropriate coordinates information to the user.

The execution order of steps S30, S32, S34, and S38 may be changed arbitrarily, and only the process selected by the user may be performed in steps S30˜S34.

The above-described process allows the control unit 60 to display the tendency of the articles of clothing that the user wore in the past and to provide an idea for coordinates to the user when the user needs coordinates.

(Process of Suggesting Coordinates with New Article of Clothing)

The process at step S38 of FIG. 7 suggests a combination of articles of clothing from the articles of clothing owned by the user, but the user needs to think coordinates with the existing articles of clothing when buying a new article of clothing. However, clothes for autumn are sold from the middle of August for example, but it is still hot in August in reality, and the wardrobe is not updated. Thus, the user is likely to purchase an article of clothing similar to or not matching up with the articles of autumn clothing that the user has because the user often has little grasp of the articles of autumn clothing that the user has when buying a new article of autumn clothing.

Accordingly, in the process of FIG. 8, executed is a process of suggesting a combination of the new article of clothing that the user plans to purchase and the articles of clothing that the user has. The process of FIG. 8 is started under the instruction of the user when the user is checking a new article of clothing in a store, or on the Internet or a magazine. The following describes a case where the user is checking a new article of clothing in a store.

In the process of FIG. 8, at step S40, the control unit 60 waits till the clothing data of the article of clothing that the user plans to purchase is input. The user may input the clothing data by reading a barcode or an electronic tag attached to the article of clothing by a terminal located in a store (and coupled to the store server 100c) and then sending the clothing data from the store server 100c to the mobile terminal 10. Or, the user may input the clothing data by capturing the image of a QR code (registered trademark) attached to the article of clothing by the image capture unit 30 of the mobile terminal 10 to read a clothing ID, and accessing the store server 100c with the ID to acquire the clothing data from the store server 100c. The user may capture the image of the article of clothing in the store to input the clothing data.

When the clothing data is input by the aforementioned method and the determination of step S40 becomes Y, the control unit 60 identifies the input new article of clothing at step S42. More specifically, the control unit 60 identifies whether the article of clothing is an upper garment or a lower garment (pants, skirt) based on the input clothing data. In addition, when the article of clothing is an upper garment, the control unit 60 identifies whether the article of clothing is an intermediate garment or an outer garment based on the input clothing data or the input from the user indicating whether the article of clothing is an intermediate garment or an outer garment.

Then, at step S44, the control unit 60 reads the information about the articles of clothing owned by the user from the clothing DB to suggest the coordinates with the article of clothing identified at step S42. Here, assume that the user inputs an autumn jacket (outer garment) as the new clothing data, and the control unit 60 reads the clothing information about jackets, intermediate garments, and pants from the clothing DB. That is to say, when the category of the input clothing data is a first category, the control unit 60 reads the clothing information belonging to a second category, which differs from the first category, together with the clothing information belonging to the first category from the clothing DB.

Then, at step S46, the control unit 60 determines whether the user has a jacket similar to the jacket that the user plans to purchase. In this case, the control unit 60 compares the clothing information of the jacket (color, design) read out from the clothing DB to the information of the jacket that the user plans to purchase (color, design) to determine whether they are similar to each other. The process moves to step S52 when the determination at step S46 is N, and moves to step S48 when the determination is Y.

Moving to step S48, the control unit 60 displays the image data of the similar jacket owned by the user on the display 12 to inform the user that the user considers the purchase of the jacket similar to the jacket that the user already has. The control unit 60 may display image data of other jackets owned by the user on the display 12.

After step S48, the control unit 60 displays a message to ask whether the user changes the jacket that the user plans to purchase on the display 12 at step S49.

Then, at step S50, the control unit 60 determines whether the user inputs the change of the jacket that the user plans to purchase through the touch panel 14. The process moves to step S40 when the determination is Y, and moves to step S52 when the determination is N.

At step S52, the control unit 60 reads the clothing information except the clothing information about outer garments, i.e. the clothing information about intermediate garments and the clothing information about pants, from the flash memory 50 and displays the coordinates suggestion (the combination of articles of clothing) on the display 12. The coordinates may be suggested by displaying the article of clothing that the user has and of which the representative color matches up with the color of the article of clothing input at step S40. More specifically, the control unit 60 may suggest (display) a combination of articles of clothing of which colors belong to the same hue or close hues such as black and gray or blue and pale blue on the display 12. In addition, as vertical-striped clothes are not generally worn together with horizontal-striped clothes, the control unit 60 does not suggest the coordinates with the articles of clothing with horizontal-stripes that the user has when the article of clothing that the user plans to purchase is with vertical stripes. Similarly, the control unit 60 does not suggest wearing the patterned clothes with the patterned clothes. The control unit 60 may display thumbnail images of the articles of clothing that the user has on the display 12 to allow the user to select at least one of them through the touch panel 14. The control unit 60 can determine whether the colors match up with each other based on predetermined templates (template that defines the appropriate combination of the color of an intermediate garment and the color of an outer garment). This allows the user to coordinate the articles of clothing that the user already has with the new jacket that the user plans to purchase while being in a store. When it is impossible to wear the article of clothing that the user plans to purchase because the user uses mail order, or trial fitting is troublesome, the control unit 60 may compares the size of the article of clothing that the user plans to purchase to that of an article of clothing that the user has. For example, when purchasing a skirt through mail order, the user is not sure whether the knees are exposed. In such a case, the control unit 60 displays the image of a skirt with the similar length on the display 12 to allow the user to check whether the knees are exposed when the user wears the skirt that the user plans to purchase. In the same manner, there is a case where the user does not know whether the length of the skirt is longer than the length of a coat when the user wears the coat. In such a case, the control unit 60 compares the length of the skirt to the length of the coat that the user has and informs the user of the comparison result. As described above, the mobile terminal 10 of the present embodiment allows the user to confirm the information about the articles of clothing belonging to the same category as the articles of clothing that the user has and the state where the user wears the article of clothing that the user plans to purchase with use of the information about the articles of clothing belonging to the category different from that of the articles of clothing that the user has.

The coordinates suggestion at step S52 may be applied to step S38 of the flowchart of FIG. 7.

Then, at step S54, the control unit 60 determines whether the user wants to continue the process. The process goes back to step S40 when the determination is Y, and the entire process of FIG. 8 is ended when it is N.

As described above, the execution of the process of FIG. 8 by the control unit 60 enables to inform the user that the new article of clothing that the user plans to purchase is similar to the article of clothing that the user has and to suggest ideas for a combination of the article of clothing that the user plans to newly purchase and the article of clothing that the user has.

As described above in detail, according to the present embodiment, the mobile terminal 10 includes the first camera 31 provided to the main unit 11, the second camera 32 and the third camera 33 provided to the main unit 11 at different locations from the first camera 31, the orientation sensor 23 detecting the orientation of the main unit 11, and the control unit 60 carrying out image capturing by the cameras depending on the detection result of the orientation sensor 23. This allows the present embodiment to capture images depending on the orientation of the main unit 11, i.e. the ranges within which the first to third cameras 31˜33 can capture images. Thus, each camera captures an image when each camera can capture an appropriate image, and thereby the appropriate image can be captured automatically, and the usability of the mobile terminal 10 is improved.

In addition, when an inappropriate image is possibly captured, for example, in a case where image capturing could be secret photographing, the present embodiment stops automatic image capturing (restricts image capturing). Therefore, the usability of the mobile terminal 10 is also improved from this view.

In the present embodiment, the first camera 31 is located on the surface at the −Y side (the principal surface) of the main unit 11 and the third camera 33 is located on the surface different from the principal surface (the surface at the +Y side). Therefore, images of the upper body and the lower body of the user can be simultaneously captured while the user is sitting or standing.

In the present embodiment, the touch panel 14 and the display 12 are located on the principal surface (the surface at the −Y side) of the mobile terminal 10, and thereby, the image of the clothes of the user (the upper body and the lower body) can be captured while the user is operating the mobile terminal 10 or viewing the display 12.

In the present embodiment, the acceleration sensor 25 detecting the posture of the user holding the main unit 11 is provided, and the control unit 60 changes the photographing condition of the third camera 33 depending on the detection result of the acceleration sensor 25. This allows the third camera 33 to capture an image when the third camera 33 can capture an appropriate image. In addition, the control unit 60 trims a captured image depending on the detection result of the acceleration sensor 25 so as not to allow the user to view a part of which image has a high probability of being not supposed to be captured in the captured image.

In the present embodiment, a pressure sensor or the like of the biosensor 22 is used to detect the hold of the mobile terminal 10 (the main unit 11) by the user, and the control unit 60 carries out image capturing by at least one of the cameras 31˜33 when the pressure sensor detects it, and thereby the image of the clothes of the user can be captured at appropriate timing.

In the present embodiment, the clothing detection unit 42 synthesizes images captured by the cameras, and thereby partial images of the user captured by the cameras (images around the face, of the upper body and of the lower body) can be integrated to form one image. This enables to analyze the clothes of the user appropriately.

In the present embodiment, the flash memory 50 storing the data about the clothes is provided, and thereby the control unit 60 can analyze the sameness between the current clothes and the past clothes of the user, or suggest ideas for the coordinates of the current clothes of the user or ideas for a combination of the article of clothing that the user plans to newly purchase and the article of clothing that the user has. In the present embodiment, the communication unit 18 acquires the data about the clothes from the external device 100, and thereby the analysis of the clothes of the user based on the data of the articles of clothing worn in the past (the articles of clothing of which images were captured by the digital camera 100a and the articles of clothing stored in the image server 100b) can be performed.

In the mobile terminal 10 of the present embodiment, the control unit 60 acquires the image data of the articles of clothing of the user, and the clothing detection unit 42 identifies a combination of the articles of clothing based on the image data. Therefore, the combination of the articles of clothing of the user can be automatically identified from the image data.

In the present embodiment, the face recognition unit 41 recognizes the face of the user from the image, and thus it is possible to easily identify the combination of the articles of clothing of the user by determining that the part below the face is the articles of clothing. In addition, the use of the face recognition result enables confirmation of the identity of the user or clothes management for each user.

In the present embodiment, the control unit 60 stores the frequency of the combination of the articles of clothing of the user in the flash memory 50, and thereby can provide the information about the frequency to the user by, for example, displaying the information on the display 12.

The mobile terminal 10 of the present embodiment includes the flash memory 50 storing the data of the articles of clothing that the user has and the communication unit 18 that inputs the information about the articles of clothing not stored in the flash memory 50. This allows the control unit 60 to suggest a combination of the article of clothing that the user plans to purchase (acquired from the store server 100c) and the article of clothing that the user has and is stored in the flash memory 50.

In the present embodiment, the control unit 60 detects the clothing data of the article of clothing similar to the article of clothing that the user plans to purchase from the data, which is stored in the flash memory 50, of the articles of clothing that the user already has and displays it on the display 12. This can prevent the user from newly purchasing an article of clothing similar to the article of clothing that the user has.

In the present embodiment, the resizing unit 43 detects a change in the shape of the body of the user, and thereby the information about the change in the shape of the body can be provided to the user.

The aforementioned embodiment describes a case where the image of the user is captured and the clothes are analyzed when the user is away from home, for example, in the train, but does not intend to suggest any limitation. For example, in the cold season, the user wears a coat, and thus there may be a case where it cannot be determined what is worn under the coat from the outside. In such a case, the image of the user may be captured only when the user is in a room (for example, the season determined from the date is winter, but the temperature (room temperature) is 15° C. or greater).

In the aforementioned embodiment, the control unit 60 suggests coordinates based on a hairstyle or the like at step S38 of FIG. 7, but this does not intend to suggest any limitation. For example, assume that the user inputs a country or a city when the user goes abroad. In such a case, the control unit 60 may acquire image data of the recent (or previous year's) clothes of a person other than the user (e.g. a person who lives in the country or the city (e.g. Denmark) and whose sex is the same as that of the user and whose age is close to that of the user) from the image server 100b and provide it. This enables to provide the information about the coordinates appropriate for the local weather and climate to the user. In this case, the control unit 60 may compare the articles of clothing of a person other than the user to the article of clothing specified by the user (e.g. the article of clothing that the user plans to purchase) and provide (display) the result of the comparison.

The description is given of a case that the user is informed of the fact that the user already has the article of clothing similar to the article of clothing that the user plans to purchase when the user is considering the purchase of a new article of clothing similar to the article of clothing that the user already has at step S48, but does not intend to suggest any limitation. For example, when the sizes of the articles of clothing are managed in the clothing DB and the size of the new article of clothing differs from the sizes of the articles of clothing that the user has, the user may be informed of the fact that the conventional clothes may not be fit to the user any more. Such information is especially effective when the clothes of children who grow vigorously are coordinated. In addition, there may be a case that the user does not know the size of the user, and thus the sizes of the articles of clothing stored in the clothing DB may be extracted and displayed on the display 12 in advance.

Furthermore, when purchasing an article of clothing for a member of the family or giving someone an article of clothing, there may be a case that the user does not know the size of the person or what kind of clothes that the person has. In such a case, the communication unit 18 may analyze the size of the member of the family or another person, or the information about articles of clothing that the member of the family or another person has from the digital camera 100a, the image server 100b, or the store server 100c, and inform the user of it.

The aforementioned embodiment describes a case where both the operation unit (the touch panel 14 in the aforementioned embodiment) and the display unit (the display 12 in the aforementioned embodiment) are located on the principal surface (the surface at the −Y side) of the mobile terminal 10. However, this does not intend to suggest any limitation, and it is sufficient if at least one of them is provided.

The aforementioned embodiment describes a case where the first to third cameras 31˜33 are provided to the main unit 11, but does not intend to suggest any limitation. It is sufficient if at least two of the first to third cameras 31˜33 are provided. That is to say, one or more cameras except the cameras described in the aforementioned embodiment may be provided to the main unit 11 in addition to the at least two cameras.

In the aforementioned embodiment, the image capture unit 30 of the mobile terminal 10 detects the information about the user's clothes, but an image capture unit may be provided to a personal computer to detect the user's clothes while the user is operating the personal computer. In addition, the mobile terminal 10 may cooperate with the personal computer to detect the information about the user's clothes or provide the coordinates information.

The aforementioned embodiment uses a mobile terminal (smartphone) having a telephone function and fitting within the palm of the user's hand as an example, but may be applied to a mobile terminal such as a tablet computer.

In the aforementioned embodiment, the control unit 60 performs the process of analyzing the user's clothes and the like, but this does not intend to suggest any limitation. A part of or the whole of the process by the control unit 60 described in the aforementioned embodiment may be performed by a processing server (cloud) coupled to the network 80.

In the mobile terminal 10, the mobile terminal 10 may not include the first to third cameras 31˜33 to identify the combination of the articles of clothing based on the image data of the articles of clothing of the user. In this case, the mobile terminal 10 acquires the image data of the articles of clothing of the user captured by an external camera through communication.

While the exemplary embodiments of the present invention have been illustrated in detail, the present invention is not limited to the above-mentioned embodiments, and other embodiments, variations and modifications may be made without departing from the scope of the present invention. The entire disclosure of the publication cited in the above description is incorporated herein by reference.

1-54. (canceled)

55. A control method of a mobile terminal comprising the steps of:
inputting data of an article of clothing owned by a first user to the mobile terminal having a display;
inputting data of an article of clothing in a store to the mobile terminal in the store; and
displaying an image of the article of clothing owned by the first user and an image of the article of clothing in the store on the display.

56. The method of claim 55, wherein the displaying includes displaying a thumbnail image of the article of clothing owned by the first user.

57. The method of claim 56, the process further comprising:
making the first user select the thumbnail image through a touch panel provided to the mobile terminal.

58. The method of claim 55, wherein the displaying includes displaying the image of the article of clothing owned by the first user on the display according to the article of clothing in the store of which the data is input.

59. The method of claim 58, wherein the displaying includes displaying an image of an article of clothing, of which a category differs from a category of the article of clothing in the store of which the data is input, out of the article of clothing owned by the first user on the display.

60. The method of claim 58, wherein the displaying includes displaying the image of the article of clothing owned by the first user according to a color of the article of clothing in the store of which the data is input.

61. The method of claim 58, wherein the displaying includes displaying the image of the article of clothing owned by the first user on the display according to a design of the article of clothing in the store of which the data is input.

62. The method of claim 55, the process further comprising:
categorizing the article of clothing owned by the first user.

63. The method of claim 62, wherein the categorizing includes categorizing the article of clothing owned by the first user by seasons.

64. The method of claim 55, wherein the inputting of the data of the article of clothing in the store includes inputting the data of the article of clothing in the store from a code provided to the article of clothing in the store.

65. The method of claim 55, the process further comprising:
displaying information about a size of the article of clothing owned by the first user and a size of the article of clothing in the store.

66. The method of claim 55, wherein the displaying includes displaying an image of an article of clothing similar to the article of clothing in the store out of the article of clothing owned by the first user on the display.

67. The method of claim 55, the process further comprising:
displaying information about coordinates of a second user different from the first user.

68. The method of claim 55, wherein the inputting of the data of the article of clothing owned by the first user includes inputting the data of the article of clothing owned by the first user by capturing an image of the article of clothing owned by the first user with use of a camera provided to the mobile terminal.

69. A control method of a mobile terminal comprising the steps of:
inputting data of an article of clothing owned by a first user to a mobile terminal having a display;
inputting information about coordinates of a second user whose sex is same as a sex of the first user to the mobile terminal; and
displaying at least one of an image of the article of clothing owned by the first user and the information about the coordinates of the second user.

70. The method of claim 69, the process further comprising:
inputting information about a hairstyle of the first user to the mobile terminal.

71. The method of claim 69, wherein the displaying includes displaying the information about the coordinates of the second user on the display according to weather.

72. The method of claim 69, wherein the inputting of the data of the article of clothing owned by the first user includes inputting the data of the article of clothing owned by the first user by capturing an image of the article of clothing owned by the first user with use of a camera provided to the mobile terminal.

73. The method of claim 69, wherein the displaying includes displaying a thumbnail image of the article of clothing owned by the first user on the display.

74. The method of claim 69, the process further comprising:
categorizing the article of clothing owned by the first user.

75. A computer readable storage medium storing a program causing a computer to execute a process, the process comprising:
inputting data of an article of clothing owned by a first user to a mobile terminal having a display;
inputting data of an article of clothing in a store to the mobile terminal in the store; and
displaying an image of the article of clothing owned by the first user and an image of the article of clothing in the store on the display.

76. A computer readable storage medium storing a program causing a computer to execute a process, the process comprising:
inputting data of an article of clothing owned by a first user to a mobile terminal having a display;
inputting information about coordinates of a second user whose sex is same as a sex of the first user to the mobile terminal; and
displaying at least one of an image of the article of clothing owned by the first user and the information about the coordinates of the second user.
